(19) United States
(12) Patent Application Publication
(10) Pub. No.: US 2024/0396139 A1
(43) Pub. Date: Nov. 28, 2024

(54) SANDWICH TYPE SUPPORT STRUCTURE

(71) Applicant: HYUNDAI MOBIS CO., LTD., Seoul (KR)

(72) Inventor: Jong Yeon PARK, Seoul (KR)

(73) Assignee: HYUNDAI MOBIS CO., LTD., Seoul (KR)

(21) Appl. No.: 18/203,273

(22) Filed: May 30, 2023

(30) Foreign Application Priority Data
May 23, 2023 (KR) 10-2023-0066063

(51) Int. Cl. H01M 50/24; H01M 50/249

(52) U.S. Cl. CPC H01M 50/24; H01M 50/249

(57) ABSTRACT

The present invention relates to a surface pressure supporting structure applied to a battery. The sandwich type support structure according to the present invention is advantageous in that air mobility performance can be improved by reducing a weight of a battery module structure, by applying a build-up sandwich structure so that high surface pressure of a battery cell can be supported even though the sandwich type support structure has a small weight.

### CROSS-REFERENCE TO RELATED APPLICATIONS

This application claims priority under 35 U.S.C. § 119 to Korean Patent Application No. 10-2023-0066063, filed on May 23, 2023, in the Korean Intellectual Property Office, the disclosure of which is incorporated herein by reference in its entirety.

### TECHNICAL FIELD

The following disclosure relates to a surface pressure supporting structure applied to a battery.

### BACKGROUND

As air mobility requires high power/high energy as compared to an electric vehicle, a battery cell having surface pressure 2 to 5 times higher than that of a lithium-ion cell used in an existing vehicle is applied to the air mobility. Accordingly, it has been required to support the surface pressure increased as compared to that in the electric vehicle, and it has been necessary to increase a thickness of a surface pressure structure as compared to the thickness of the conventional surface pressure structure or add a reinforcing shape to the surface pressure structure. As a result, the weight of the surface pressure structure has finally increased, causing a problem in that it is not possible to satisfy the weight reduction requirement, which is an important factor in air mobility performance.

More specifically, the conventional surface pressure structure includes a surface pressure plate and a beam that are made of a metal material to support surface pressure. In order for the surface pressure plate, to which a large load is exerted, to secure sufficient rigidity, a reinforcing shape is added to the surface pressure plate by using a bead, a stiffener, or the like. However, when the conventional surface pressure plate made of a metal material is applied to a battery of which surface pressure is increased because high power/high energy is required, it is necessary to increase the thicknesses of the surface pressure plate and the beam that are made of a metal material or apply additional reinforcing parts, causing a problem in that the weight of the surface pressure structure increases.

### PRIOR ART DOCUMENT

### Patent Document

(Patent Document 1) Korean Patent No. 10-1252949 entitled “BATTERY MODULE” issued on Apr. 3, 2013

### SUMMARY

An embodiment of the present invention is directed to providing a sandwich type support structure that is advantageous in that air mobility performance can be improved by reducing a weight of a battery module structure, by applying a build-up sandwich structure so that high surface pressure of a battery cell can be supported even though the sandwich type support structure has a small weight.

In one general aspect, a sandwich type support structure contacting one surface of a battery module to offset surface pressure includes: a plate-shaped inner skin part of which one surface is in contact with one surface of the battery module; and a plate-shaped outer skin part of which one surface is in contact with a surface of the inner skin part that is not in contact with the battery module, wherein the outer skin part includes a reinforcing portion bent to protrude in an opposite direction of the battery module.

The sandwich type support structure may further include a reinforcing frame inserted between the inner skin part and the outer skin part, wherein the reinforcing portion includes an accommodating portion bent to protrude to a height equal to a thickness of the reinforcing frame.

The reinforcing frame may be disposed parallel to one edge of the battery module.

The reinforcing frame may be disposed to form an angle greater than 0 degrees and less than 90 degrees with one edge of the battery module.

The reinforcing frame may have a “u”-shaped cross section in a thickness direction thereof.

The reinforcing frame may have a rectangular-shaped cross section in a thickness direction thereof with a hollow inside.

The reinforcing frame may further include additional reinforcing portions at both ends in a thickness direction thereof, and the additional reinforcing portions may extend in a direction perpendicular to the thickness direction.

The reinforcing portion may further include an outer support portion bent from at least one of upper and lower ends of the outer skin part in the opposite direction of the battery module.

The inner skin part may include a seating portion bent to protrude in the opposite direction of the battery module and formed in a shape corresponding to an outer edge of a surface of the reinforcing frame contacting the inner skin part.

The inner skin part may extend from a surface contacting the outer skin part, and be bent at a position corresponding to an edge of the battery module to contact two or more surfaces of the battery module.

The sandwich type support structure having the above-described configuration according to the present invention is advantageous in that air mobility performance can be improved by reducing a weight of a battery module structure, by applying a build-up sandwich structure so that high surface pressure of a battery cell can be supported even though the sandwich type support structure has a small weight.

### BRIEF DESCRIPTION OF THE DRAWINGS

FIG. 1 is a perspective view illustrating a sandwich type support structure according to the present invention.

FIG. 2 is a schematic diagram illustrating a configuration of the sandwich type support structure according to the present invention.

FIG. 3 is a perspective view illustrating a sandwich type support structure to which a first embodiment of a reinforcing frame according to the present invention is applied.

FIG. 4 is a perspective view illustrating a sandwich type support structure to which a second embodiment of a reinforcing frame according to the present invention is applied.

FIG. 5 is a cross-sectional view illustrating a sandwich type support structure to which a third embodiment of a reinforcing frame according to the present invention is applied.

FIG. 6 is a cross-sectional view illustrating a sandwich type support structure to which a fourth embodiment of a reinforcing frame according to the present invention is applied.

FIG. 7 is a cross-sectional view illustrating a sandwich type support structure to which a fifth embodiment of a reinforcing frame according to the present invention is applied.

FIG. 8 is a cross-sectional view illustrating a sandwich type support structure to which a first embodiment of an inner skin part according to the present invention is applied.

FIG. 9 is a cross-sectional view illustrating a sandwich type support structure to which a second embodiment of an inner skin part according to the present invention is applied.

### DETAILED DESCRIPTION OF MAIN ELEMENTS

1000: Sandwich type support structure
100: Inner skin part
110: Seating portion
200: Outer skin part
210: Reinforcing portion
211: Accommodating portion
212: Outer support portion
300: Reinforcing frame
310: Additional reinforcing portion
M: Battery module

### DETAILED DESCRIPTION OF EMBODIMENTS

Hereinafter, the technical idea of the present invention will be described in more detail with reference to the accompanying drawings. Further, terms or words used in the specification and claims herein should not be interpreted as being limited to the ordinary or dictionary meanings, but interpreted as meanings and concepts corresponding to the technical idea of the present invention based on the principle that the inventor can appropriately define concepts of terms to describe his/her invention in the best way.

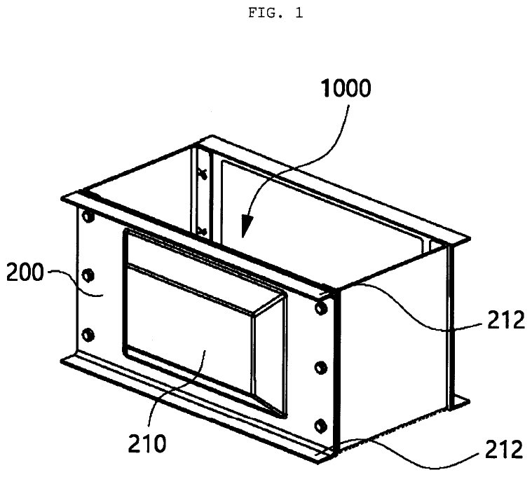

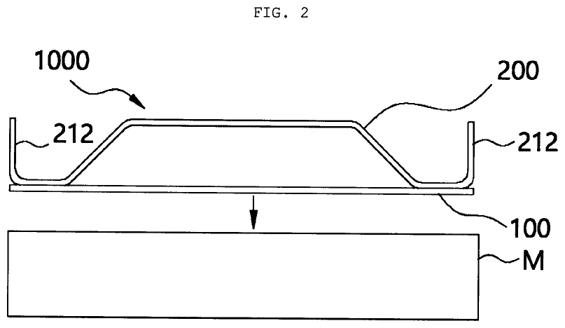

Hereinafter, a basic configuration of a sandwich type support structure 1000 according to the present invention will be described with reference to FIGS. 1 and 2.

As illustrated in FIGS. 1 and 2, the sandwich type support structure 1000 according to the present invention is in contact with one surface of a battery module M to offset surface pressure, and may include an inner skin part 100 and an outer skin part 200. The inner skin part 100 may be a plate of which one surface is in contact with one surface of the battery module M, and the outer skin part 200 may be a plate of which one surface is in contact with a surface of the inner skin part 100 that is not in contact with the battery module M. In this case, the outer skin part 200 of the sandwich type support structure 1000 according to the present invention includes a reinforcing portion 210 bent to protrude in the opposite direction of the battery module M to more effectively support surface pressure of the battery module M. Such a sandwich structure of the sandwich type support structure 1000 according to the present invention is capable of increasing the moment of inertia about the neutral axis and effectively increasing the bending stiffness of the battery module M against surface pressure.

In this case, the outer skin part 200 and the inner skin part 100 may have a thickness of 50% or less of the thickness of the conventional surface pressure plate. In addition, the reinforcing portion 210 may have a protruding height equal to or greater than the thickness of the conventional surface pressure plate. As a result, the sandwich type support structure 1000 according to the present invention can more effectively support surface pressure without increasing its thickness as compared with the conventional surface pressure plate. In addition, the outer skin part 200 and the inner skin part 100 may include a metal material (aluminum, steel, or the like) or a composite material (CFRP, GFRP, or the like). The outer skin part 200 and the inner skin part 100 may be coupled to each other by perforating them and inserting a fastener therebetween, by welding edges contacting each other thereof, or by bonding them.

As an example, the reinforcing portion 210 may further include an outer support portion 212 bent from at least one of upper and lower ends of the outer skin part 200 in the opposite direction of the battery module M. The outer support portion 212 may be integrally formed with the outer skin part 200. Accordingly, the bending stiffness of each edge can be increased, and the overall shape of the sandwich type support structure 1000 can be easily maintained.

Furthermore, in order to confirm the surface pressure supporting effect when the sandwich type support structure 1000 according to the present invention including the outer skin part 200 and the inner skin part 100 is applied to the battery module M, stress distribution was simulated under a predetermined surface pressure condition in a state where the thickness of each of the outer skin part 200 and the inner skin part 100 according to the present invention was set to 1.5 mm. As a result, it was confirmed that the highest stress was 874 MPa and occurred in a central portion of the inner skin part 100. In a conventional surface pressure structure having a thickness of 3 mm, the highest stress was 1130 MPa and occurred near a fastener coupled to an outer structure. When the sandwich type support structure 1000 according to the present invention is compared with the conventional surface pressure structure, the highest stress decreased by 58% and the position at which the highest stress occurred was a partial region of the inner skin part 100, confirming that surface pressure was stably supported.

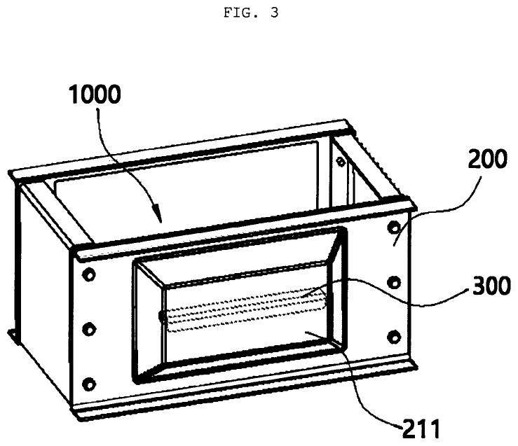

Hereinafter, a reinforcing frame 300 of the sandwich type support structure 1000 according to an embodiment of the present invention will be described with reference to FIGS. 3 to 7.

The sandwich type support structure 1000 according to an embodiment of the present invention may further include a reinforcing frame 300 inserted between the outer skin part 200 and the inner skin part 100. In this case, the reinforcing portion 210 may include an accommodating portion 211 bent to protrude to a height equal to the thickness of the reinforcing frame 300 in order to accommodate the reinforcing frame 300. The reinforcing frame 300 may be bonded to the outer skin part 200 and the inner skin part 100, or the reinforcing frame 300 may be fixed to the outer skin part 200 and the inner skin part 100 through fasteners or the like after perforating them.

In this case, the accommodating portion 211 may protrude in such a manner that a cross-sectional area decreases as a protruding height increases. That is, the accommodating portion 211 may protrude in a truncated pyramid shape. More specifically, the accommodating portion 211 may have a side surface inclined at an angle greater than or equal to 30 degrees and less than 60 degrees. As a result, it is easy to mold the outer skin part 200, and it is also possible to increase the bending stiffness against surface pressure. This shape of the accommodating portion 211 may be applied to all embodiments of the reinforcing frame 300 to be described below.

In addition, in a first embodiment of the reinforcing frame 300 of the sandwich type support structure 1000 according to the present invention as illustrated in FIG. 3, the reinforcing frame 300 may be disposed parallel to one edge of the battery module M. More specifically, the reinforcing frame 300 may be disposed parallel to a longer edge of a surface of battery module M contacting the outer skin part 200 and the inner skin part 100 to which the reinforcing frame 300 is applied. As a result, it is possible to minimize a variation in bending stiffness for each section of the sandwich type support structure 1000.

In order to confirm the effect of the sandwich type support structure 1000 according to the present invention to which the first embodiment of the reinforcing frame 300 was applied, stress distribution was simulated under a predetermined surface pressure condition, and compared with that in a case where the same surface pressure was applied to the basic form of the sandwich type support structure 1000 only including the outer skin part 200 and the inner skin part 100 without the reinforcing frame 300 according to the present invention. As a result, it was confirmed that the highest stress was 660 MPa and occurred at an edge of the reinforcing portion 210 when the first embodiment of the reinforcing frame 300 was applied, whereas the highest stress was 874 MPa and occurred at the center of the inner skin part 100 in a case where the reinforcing frame 300 was not applied. That is, in a case where the first embodiment of the reinforcing frame 300 was applied, the highest stress decreased by 24% and the position at which the highest stress occurred was an edge of the protruding reinforcing portion 210, confirming that surface pressure was more stably supported than that in a case where the reinforcing frame 300 was not applied.

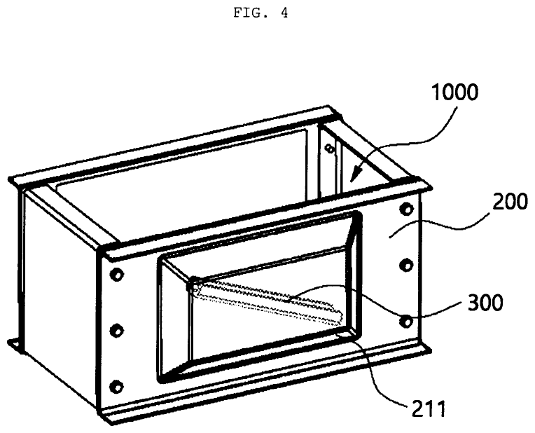

In addition, in a second embodiment of the reinforcing frame 300 of the sandwich type support structure 1000 according to the present invention as illustrated in FIG. 4, the reinforcing frame 300 is preferably disposed to form an angle greater than 0 degrees and less than 90 degrees with one edge of the battery module M. More specifically, the reinforcing frame 300 may be disposed to be inclined in a direction parallel to a diagonal of a surface of battery module M contacting the outer skin part 200 and the inner skin part 100 to which the reinforcing frame 300 is applied. As a result, it is possible to minimize a variation in bending stiffness for each section of the sandwich type support structure 1000.

In order to confirm the effect of the sandwich type support structure 1000 according to the present invention to which the second embodiment of the reinforcing frame 300 was applied, stress distribution was simulated under a predetermined surface pressure condition, and compared with that in a case where the same surface pressure was applied to the sandwich type support structure 1000 according to the present invention to which the first embodiment of the reinforcing frame 300 was applied. As a result, it was confirmed that the highest stress was 537 MPa and occurred in an entire region other than the reinforcing portion 210 when the second embodiment of the reinforcing frame 300 was applied, whereas the highest stress was 660 MPa and occurred at the edge of the reinforcing portion 210 in a case where the first embodiment of the reinforcing frame 300 was applied. That is, in a case where the second embodiment of the reinforcing frame 300 was applied, the highest stress decreased by 19% and the highest stress occurred uniformly, confirming that surface pressure was more stably supported than that in a case where the first embodiment of the reinforcing frame 300 was applied.

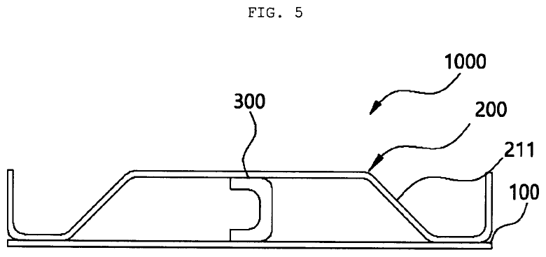

In a third embodiment of the reinforcing frame 300 of the sandwich type support structure 1000 according to the present invention as illustrated in FIG. 5, the reinforcing frame 300 may be bent in a “u” shaped in its cross section in the thickness direction. In this case, surfaces facing each other of the reinforcing frame 300 may be fixed in contact with the outer skin part 200 and the inner skin part 100, respectively. The reinforcing frame 300 may be bonded to the outer skin part 200 and the inner skin part 100, or the reinforcing frame 300 may be fixed to the outer skin part 200 and the inner skin part 100 through fasteners or the like. By bending the reinforcing frame 300, it is possible to more effectively support surface pressure applied to the surfaces of the outer skin part 200 and the inner skin part 100 in the vertical direction.

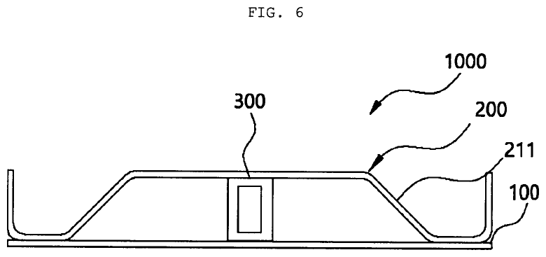

In a fourth embodiment of the reinforcing frame 300 of the sandwich type support structure 1000 according to the present invention as illustrated in FIG. 6, the reinforcing frame 300 preferably has a rectangular-shaped with a hollow inside in its cross section in the thickness direction. The reinforcing frame 300 may be bonded to the outer skin part 200 and the inner skin part 100, or the reinforcing frame 300 may be fixed to the outer skin part 200 and the inner skin part 100 through fasteners or the like. By forming the hollow inside the reinforcing frame 300, it is possible to more effectively support surface pressure applied to the surfaces of the outer skin part 200 and the inner skin part 100 in the vertical direction.

In order to confirm the effect of the sandwich type support structure 1000 according to the present invention to which the fourth embodiment of the reinforcing frame 300 was applied, stress distribution was simulated under a predetermined surface pressure condition, and compared with that in a case where the same surface pressure was applied to the sandwich type support structure 1000 according to the present invention to which the first embodiment of the reinforcing frame 300 was applied. As a result, it was confirmed that the highest stress was 552 MPa and occurred in an entire region other than the reinforcing portion 210 when the fourth embodiment of the reinforcing frame 300 was applied, whereas the highest stress was 660 MPa and occurred at the edge of the reinforcing portion 210 in a case where the first embodiment of the reinforcing frame 300 was applied. That is, in a case where the fourth embodiment of the reinforcing frame 300 was applied, the highest stress decreased by 16% and the highest stress occurred uniformly, confirming that surface pressure was more stably supported than that in a case where the first embodiment of the reinforcing frame 300 was applied.

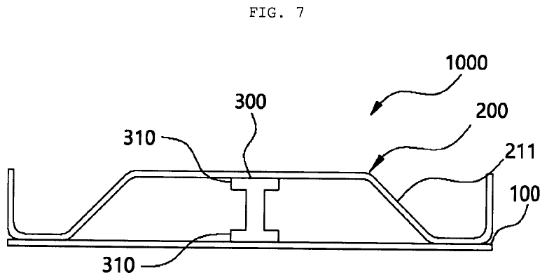

In a fifth embodiment of the reinforcing frame 300 of the sandwich type support structure 1000 according to the present invention as illustrated in FIG. 7, it is preferable that the reinforcing frame 300 further includes additional reinforcing portions 310 at both ends thereof in the thickness direction, and the additional reinforcing portions 310 extend in a direction perpendicular to the thickness direction. That is, the reinforcing frame 300 may have an “I”-shaped cross section in the thickness direction. In this case, the additional reinforcement portions 310 at both ends of the reinforcing frame 300 may be in contact with the inner skin part 100 and the outer skin part 200, respectively, to support the framework of the sandwich type support structure 1000.

In order to confirm the effect of the sandwich type support structure 1000 according to the present invention to which the fifth embodiment of the reinforcing frame 300 was applied, stress distribution a was simulated under predetermined surface pressure condition, and compared with that in a case where the same surface pressure was applied to the sandwich type support structure 1000 according to the present invention to which the first embodiment of the reinforcing frame 300 was applied. As a result, it was confirmed that the highest stress was 589 MPa and occurred in an entire region other than the reinforcing portion 210 when the fifth embodiment of the reinforcing frame 300 was applied, whereas the highest stress was 660 MPa and occurred at the edge of the reinforcing portion 210 in a case where the first embodiment of the reinforcing frame 300 was applied. That is, in a case where the fifth embodiment of the reinforcing frame 300 was applied, the highest stress decreased by 11% and the highest stress occurred uniformly, confirming that surface pressure was more stably supported than that in a case where the first embodiment of the reinforcing frame 300 was applied.

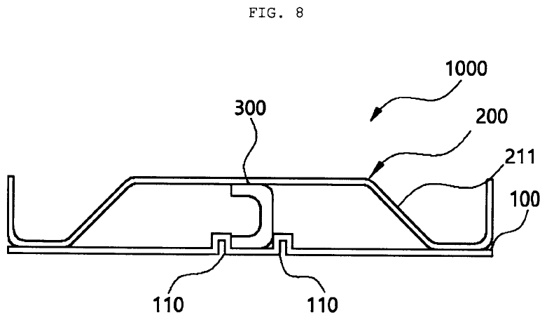

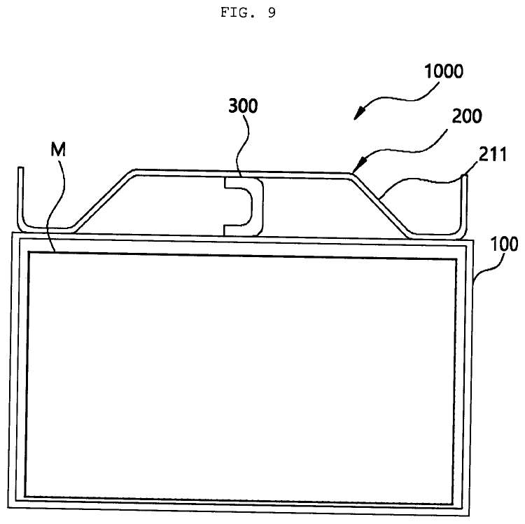

Hereinafter, embodiments of the inner skin part 100 will be described with reference to FIGS. 8 and 9.

In a first embodiment of the inner skin part 100 as illustrated in FIG. 8, the inner skin part 100 preferably includes a seating portion 110 bent to protrude in the opposite direction of the battery module M and formed in a shape corresponding to an outer edge of the surface of the reinforcing frame 300 contacting the inner skin part 100. The seating portion 110 makes it easy to assemble and disassemble the reinforcing frame 300 and the inner skin part 100 even though a separate perforation process is not performed or an separate additive or the like is not included, thereby making it easy to change the design, and makes it easy to reuse the reinforcing frame 300, the inner skin part 100, and the outer skin part 200, thereby reducing manufacturing costs.

In a second embodiment of the inner skin part 100 as illustrated in FIG. 9, the inner skin part 100 may extend from a surface contacting the outer skin part 200 and be bent at a position corresponding to an edge of the battery module M to contact two or more surfaces of the battery module M. That is, the structure supporting the battery module M by surrounding all the surfaces of the battery module M can be constituted by one part, i.e. the inner skin part 100. As a result, it is possible to simplify the manufacturing and the process, and it is possible to form a surface pressure supporting structure even though a perforation process is performed at an end of each of the plates to connect the plates to each other. Ultimately, it is possible to more effectively support surface pressure by preventing stress from being concentrated at a portion where the plates are coupled to each other.

The technical idea should not be interpreted as being limited to the above-described embodiments of the present invention. The present invention is applicable in a variety of ranges, and may be modified in various manners by those skilled in the art without departing from the gist of the present invention claimed in the claims. Therefore, such improvements and modifications fall within the protection scope of the present invention as long as they are obvious to those skilled in the art.

What is claimed is:

1. A sandwich type support structure contacting one surface of a battery module to offset surface pressure, the sandwich type support structure comprising:
a plate-shaped inner skin part of which one surface is in contact with one surface of the battery module; and
a plate-shaped outer skin part of which one surface is in contact with a surface of the inner skin part that is not in contact with the battery module,
wherein the outer skin part includes a reinforcing portion bent to protrude in an opposite direction of the battery module.

2. The sandwich type support structure of claim 1 further comprising a reinforcing frame inserted between the inner skin part and the outer skin part,
wherein the reinforcing portion includes an accommodating portion bent to protrude to a height equal to a thickness of the reinforcing frame.

3. The sandwich type support structure of claim 2, wherein the reinforcing frame is disposed parallel to one edge of the battery module.

4. The sandwich type support structure of claim 2, wherein the reinforcing frame is disposed to form an angle greater than 0 degrees and less than 90 degrees with one edge of the battery module.

5. The sandwich type support structure of claim 2, wherein the reinforcing frame has a “u”-shaped cross section in a thickness direction thereof.

6. The sandwich type support structure of claim 2, wherein the reinforcing frame has a rectangular-shaped cross section in a thickness direction thereof with a hollow inside.

7. The sandwich type support structure of claim 2, wherein the reinforcing frame further includes additional reinforcing portions at both ends in a thickness direction thereof, and
the additional reinforcing portions extend in a direction perpendicular to the thickness direction.

8. The sandwich type support structure of claim 2, wherein the reinforcing portion further includes an outer support portion bent from at least one of upper and lower ends of the outer skin part in the opposite direction of the battery module.

9. The sandwich type support structure of claim 2, wherein the inner skin part includes a seating portion bent to protrude in the opposite direction of the battery module and formed in a shape corresponding to an outer edge of a surface of the reinforcing frame contacting the inner skin part.

10. The sandwich type support structure of claim 1, wherein the inner skin part extends from a surface contacting the outer skin part, and is bent at a position corresponding to an edge of the battery module to contact two or more surfaces of the battery module.
